(19) United States
(12) Patent Application Publication
(10) Pub. No.: US 2014/0210302 A1
(43) Pub. Date: Jul. 31, 2014

(54) MOTOR FOR USE IN REFRIGERANT ENVIRONMENT

(71) Applicant: Regal Beloit America, Inc., Beloit, WI (US)

(72) Inventors: Peter Bernard Vodak, Waukesha, WI (US); Martin Thomas Lange, Troy, OH (US)

(73) Assignee: Regal Beloit America, Inc., Beloit, WI (US)

(21) Appl. No.: 14/166,424

(22) Filed: Jan. 28, 2014

Related U.S. Application Data
(60) Provisional application No. 61/757,380, filed on Jan. 28, 2013.

(51) Int. Cl. H02K 3/487

(52) U.S. Cl. CPC H02K 3/487
USPC 310/214

(57) ABSTRACT

A motor for use within a refrigerant atmosphere includes a plurality of laminations stacked along an axis, the laminations cooperating to define a plurality of teeth and a slot disposed between each pair of adjacent teeth, a plurality of coils each positioned around a tooth such that each coil is partially disposed in two adjacent slots, and a first phase winding formed from at least two coils, the first phase winding including a single continuous conductor. An insulating member is disposed within each of the slots and arranged to electrically insulate the coil within the respective slot from the laminations and a wedge is positioned within at least one of the slots. The wedge is operable to compress the coil within the slot. A rotor is positioned adjacent the stator and is operable to rotate about the axis.

### RELATED APPLICATION DATA

This application claims priority to U.S. Provisional Application No. 61/757,380 filed Jan. 28, 2013, the entire contents of which are incorporated herein by reference.

### BACKGROUND

The present invention relates to electric motors for use in an ammonia environment. More specifically, the present invention relates to motors for use in an ammonia environment and driven by a variable frequency drive.

### SUMMARY

In one construction, the invention provides a motor that includes a stator formed from a plurality of laminations stacked along the rotational axis to define a core thickness. The laminations cooperate to define a plurality of teeth with each tooth cooperating with an adjacent tooth to define a slot. A plurality of coils are formed from wires that wrap around the teeth such that the wires are disposed within the slots. Wedges are positioned between the teeth and the coils to restrain the coils within the slots. Slot liners are positioned between the wires and the laminations. In preferred constructions, the wires include a copper or aluminum conductor surrounded by an extruded insulator formed from a PEEK material. The slot liners are formed using PPS sheets.

In another construction, the invention provides a motor for use within a refrigerant atmosphere, the motor comprising a plurality of laminations stacked along an axis, the laminations cooperating to define a plurality of teeth and a slot disposed between each pair of adjacent teeth, a plurality of coils each positioned around a tooth such that each coil is partially disposed in two adjacent slots, and a first phase winding formed from at least two coils, the first phase winding including a single continuous conductor. An insulating member is disposed within each of the slots and arranged to electrically insulate the coil within the respective slot from the laminations and a wedge is positioned within at least one of the slots. The wedge is operable to compress the coil within the slot. A rotor is positioned adjacent the stator and is operable to rotate about the axis.

In another construction, the invention provides a refrigeration system that includes a compressor chamber sized to contain a quantity of refrigerant, a compressor disposed within the compressor chamber and operable to draw in low pressure refrigerant from the compressor chamber and to discharge high pressure refrigerant, and a motor completely disposed within the compressor chamber and coupled to the compressor to drive the compressor. The motor includes a rotor positioned to rotate about a rotational axis and a stator positioned adjacent the rotor and cooperating with the rotor to produce rotation of the rotor. The stator includes a first phase winding that is formed by a single continuous conductor.

Other aspects of the invention will become apparent by consideration of the detailed description and accompanying drawings.

### BRIEF DESCRIPTION OF THE DRAWINGS

FIG. 1 is a schematic illustration of a refrigeration system including a compressor and a motor;

FIG. 2 is a perspective view of a stator;

FIG. 3 is a more detailed perspective view of the stator of FIG. 2;

FIG. 4 is an end view of one of the slots illustrating the wire windings;

FIG. 5 is a cross-section of one of the winding wires;

FIG. 6 is a perspective view of a rotor; and

FIG. 7 is a cross-section of a lead wire.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

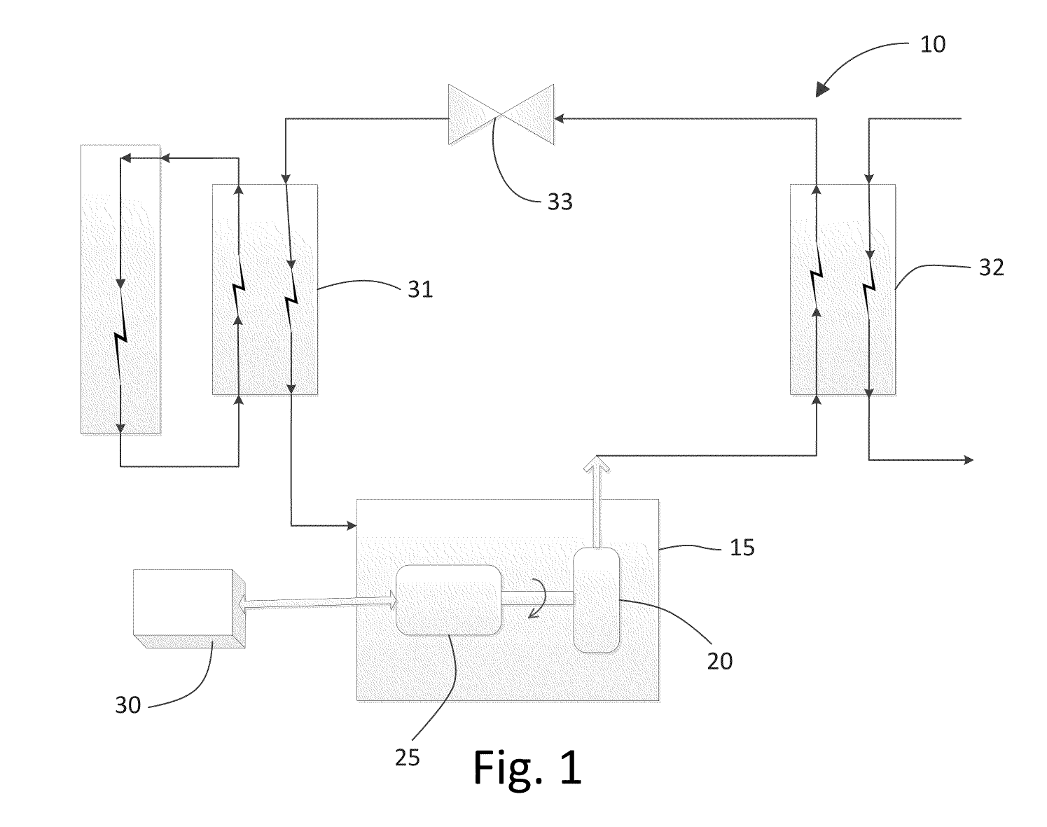

FIG. 1 illustrates a refrigeration system 10 that includes a compressor chamber 15 that contains a compressor 20 driven by an electric motor 25. The refrigeration system 10 also includes an evaporator 31, a condenser 32, and an expansion valve 33. The refrigeration system 10 is adapted for use with a refrigeration fluid such as ammonia. In one embodiment, the ammonia is refrigerant grade R-717 ammonia.

The compressor 20 could include one of a variety of different types of compressors including rotary screw, reciprocating, scroll, centrifugal, and the like. The actual style of compressor employed is not critical to the invention. Rather, all that is required is that the compressor 20 includes a stationary portion and a rotary portion coupled to a compressor shaft.

In preferred constructions, the motor 25 is a hermetic motor specifically designed to be submerged within a refrigerant atmosphere. The motor 25 can utilize an external power supply that can be line-fed or inverter-fed.

Motors 25 for ammonia compressors 20 are typically located outside the compressor chamber 15 and use either a shaft seal or a magnetic coupling to connect the motor 25 to the compressor shaft. This has been necessary because of the chemical aggressiveness of refrigerant (e.g., ammonia) towards standard materials of motor construction. Additionally, exposure to high temperature/pressure ammonia causes typical insulation materials to lose their resistance, which in turn causes premature motor failure. The present invention constructs the motor 25 out of materials that are more resistant to ammonia and uses techniques and arrangements that enhance the effectiveness of the materials, thereby allowing the motor 25 to be placed in the ammonia environment while operating satisfactorily for a sufficient length of time.

As illustrated in FIG. 1, the motor 25 and the compressor 20 are positioned inside the compressor chamber 15 to save space and provide the motor 25 the benefit of cooling from the refrigerant. This cooling of the motor 25 potentially allows for the use of smaller motors to achieve the same performance. Additionally, placing the motor 25 inside the compressor chamber 15 eliminates any potential leakage paths through external shaft seals. Finally, placing the motor 25 inside the compressor chamber 15 allows for a lower cost unit due to the elimination of duplicate brackets and bearings required to connect the motor externally. The compressor shaft can also be made shorter, shaft seals are eliminated, and magnetic couplings are not needed.

In preferred constructions, the motor 25 employs a Variable Frequency Drive (VFD) 30 to improve the efficiency of the refrigeration system 10 when compared to more conventional line-fed systems. The VFD 30 utilizes a control system that is sensitive to motor current draw and system leakage current.

The motor construction must be modified to assure that there are little or no areas in which the ammonia can make contact with electrically conductive areas within the motor windings or inter-pole connections. Because ammonia has a higher conductivity to electrical current then typical refrigerants used in hermetic compressors and because the motor stator resides in the ammonia, leakage current that might occur will likely be larger than on a motor not disposed in ammonia. Such current leakages would be more likely to cause the VFD motor protection to remove power to the motor 25. To reduce this likelihood, the motor 25 incorporates a stator winding in which no internal connections are present (i.e., each phase winding is continuous). The elimination of internal connections reduces the likelihood of any potential for leakage current to exist due to the ammonia refrigerant.

The motor 25 includes a stator 35 and a rotor 40 disposed adjacent the stator 35 and drivingly connected to the driven shaft of the compressor 20. In the illustrated construction, the rotor 40 includes a portion disposed within a cavity 45 of the stator 35. However, other motor arrangements could also be employed to drive the compressor 20.

The electric motor 25 is positioned within the refrigeration system 10 such that it is directly coupled to the compressor 20 and such that it is directly exposed to the refrigerant, in the illustrated example ammonia. Positioning the motor 25 in this way provides for more efficient transfer of power between the motor 25 and the compressor 20 and also provides more effective cooling of the motor 25 using the refrigerant as a coolant. However, refrigerant can be detrimental to many typical motor components.

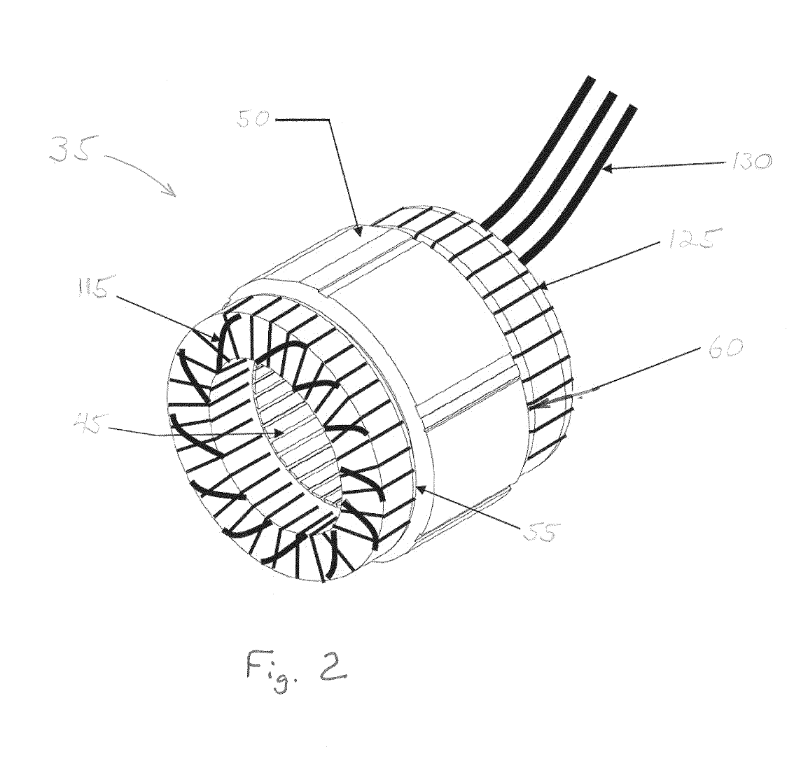

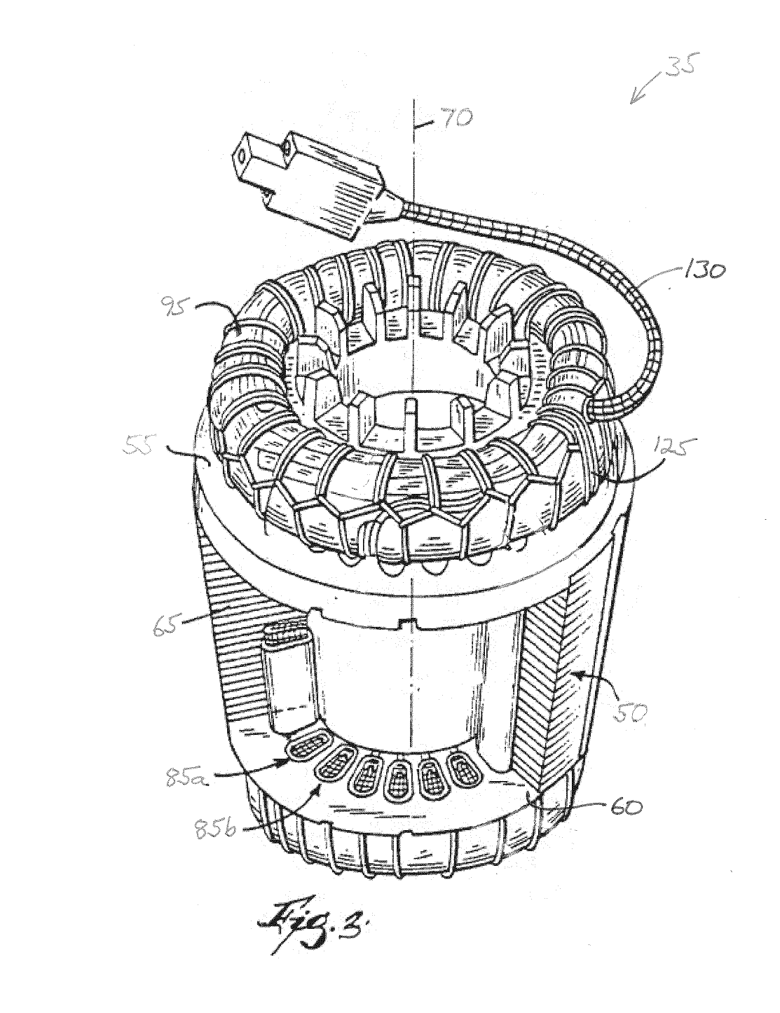

With reference to FIGS. 2-4, the stator 35 defines a cavity 45 that receives a portion of the rotor 40. The stator 35 includes a core 50 defining opposite end portions 55, 60. The stator core 50 includes a plurality of circumferentially spaced stacked metal laminations 65 disposed parallel to a centerline 70 of the cavity 45. In one embodiment, the metal laminations 65 consist of electrical grade lamination steel with other materials or constructions such as powdered metal portions being possible. As is best illustrated in FIG. 4, the stator core 50 includes a plurality of teeth 75 that each defines a pair of circumferentially spaced longitudinal slot walls 80. The slot walls 80 of adjacent teeth 75 cooperate with one another to define longitudinal slots 85 in the periphery of the stator 35. Each tooth also defines two hooks 90.

Circumferentially spaced coils are arranged with each coil disposed on one of the teeth 75 such that each coil is disposed at least partially in two slots 85. Each coil consists of a plurality of windings of wire 95 with portions of the windings of wire 95 extending longitudinally in the slots 85 in which the coil resides. Thus, each coil is defined by a plurality of windings of the wire 95 repeatedly passing through a first slot 85a, around the first end portion 55, passing through a second slot 85b adjacent the first slot 85a, around the second end portion 60, and again through the first slot 85a.

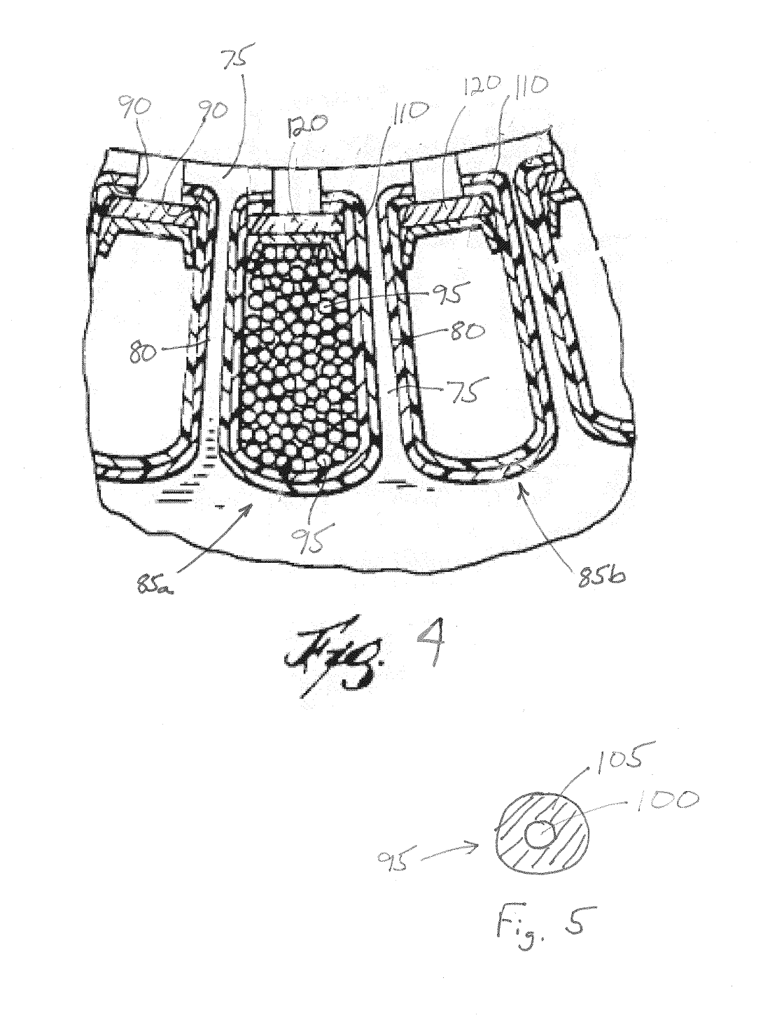

As best shown in FIG. 5, the wire 95 consists of conductive material 100 immediately surrounded by wire insulation 105. In the illustrated construction, copper or aluminum wire 100 is used as the conductor 100 with aluminum being favored in an ammonia environment. In preferred constructions, polyetheretherketone (PEEK) material is used to form the insulation 105. While some constructions may use conductors 100 coated with PEEK insulation 105, a preferred construction employs extruded PEEK insulation 105 as testing has shown significant performance increases using this construction. Specifically, the extruded PEEK insulation 105 exhibits improved toughness and superior dielectric properties when compared to coated insulation.

Slot liners 110 are provided in the slots 85 between the windings of wire 95 and the respective slot walls 80 to further insulate the windings 95 from the magnetic core 50. In preferred constructions, the slot liners 110 are formed from sheets of polyphenylene sulfide (PPS). While various thicknesses of slot liners 110 are possible, one preferred construction employs slot liners 110 that are between about 0.01 and about 0.02 inches in thickness. The sheet material provides better formability and more robust properties than other materials that were tested.

In high voltage, multi-phase applications, the stator 35 may include interphase insulators 115, sometimes referred to as phase paper, between the coils to further insulate the different phases of the motor 25. In preferred constructions, phase paper 15 is employed and is made using sheets of a polyphenylene sulfide (PPS) material similar to that of the slot liners 110. As with the slot liners 110, the sheets provided improved characteristics when compared to other material choices.

When winding the stator 35, there is typically space within the slots 85 that is not filled. Wedges 120 are typically positioned within the slots 85 to take up this space, assure that the individual windings of wire 95 are packed as tightly as possible, and to limit unwanted movement of the wires 95. Although several different wedges 120 can be used to fill the desired space, in the illustrated construction longitudinally extending wedges 120 are employed. Each wedge 120 is positioned between a respective slot liner 110 and the stack of windings 95 within the slot 85. The wedge 120 engages the underside of two adjacent hooks 90 formed as part of the adjacent teeth 75 to apply a compressive force to the wires 95. In some constructions, pegs are positioned between the wires 95 and the wedge 120 to take up additional space and to provide a flatter engagement surface for the wedges 120. While many materials are available for wedges 120 and pegs, preferred constructions employ wedges 120, and pegs if used, that are formed from one of an epoxide laminate, a polyphenylene sulfide (PPS), and a polyetheretherketone (PEEK) material. The wedges 120 and pegs (if employed) are secured in interlocking relationship with the stator core 50 to prevent radially outward movement of the coils 95 relative to the stator core 50. It should be noted that any combination of the three identified materials could be employed for the construction of the stator 35. For example, pegs could be formed from a PEEK material with wedges 120 formed from PPS if desired. Alternatively, components could be manufactured as composites. For example, pegs or wedges 120 could be formed with a wood core that is coated or covered with extruded PEEK, PPS, or epoxide laminate material.

In some constructions, the stator 35 includes lacing cord 125 laced about the end turns of the coils. The lacing 125 tightly secures the end turns of the coils, thereby reducing unwanted movement or vibration. In preferred constructions, lacing tape 125 is formed from a NOMEX® tape. Of course, other constructions may use other materials (e.g., KEVLAR®, other meta-aramids, para-aramids, etc.) for lacing 125.

The stator 35 also includes lead wire 130 that provides for a connection between the coils and the source of electrical power. As illustrated in FIG. 7, the lead wire 130 includes conductive material 125 (e.g., copper, aluminum, etc.) immediately surrounded by lead wire insulation 140. For example, one construction employs conductive material 135 consisting of wound strands of aluminum with lead wire insulation 140 formed from a fluoropolymer such as TEFLON® (i.e., polytetrafluoroethylene (PTFE)). In preferred constructions, the insulation 140 is formed over the motor leads to seal the leads and provide the desired insulation. In some constructions, the insulating material is provided in the form of a tape that is wrapped in overlapping relationship about the conductor 135 such that the proportion of tape overlap is at least about 50%. In one embodiment, the lead wire insulation 140 includes TEFLON® tape wrapped in overlapping relationship and strands or filaments of fiberglass overbraided over the TEFLON® tape. The fiberglass filaments provide a flexible abrasion-resistant covering over the TEFLON® tape. In an alternative embodiment (not shown), the motor can be leadless, such that the wire is directly connected to power terminals.

The stator 35 may also include sleeving 145 which protects the lead wire 130 and further insulates the lead wires 130 from each other at crossovers between the coils. In one embodiment, the sleeving 145 consists of a fluoropolymer such as TEFLON® (i.e., polytetrafluoroethylene (PTFE)).

The assembled stator 35 is coated or covered with an impregnating varnish 150 such as an epoxy varnish. The epoxy varnish 150 is coated over the end turns of the coils and preferably can be applied to all of the exposed surfaces of the stator 35. The epoxy varnish 150 can be applied in any suitable manner, such as by immersing the end turns of the coils, or the entire stator, in the liquid varnish or by trickle application of the liquid varnish. The impregnating varnish 150 seals the coils from the ammonia environment, bonds the wires 95 together and thus reduces movement of the wires 95 relative to one another, reduces noise from the motor 25, coats and bonds the laminations 65 in the stator 35, and anchors the interphase insulation.

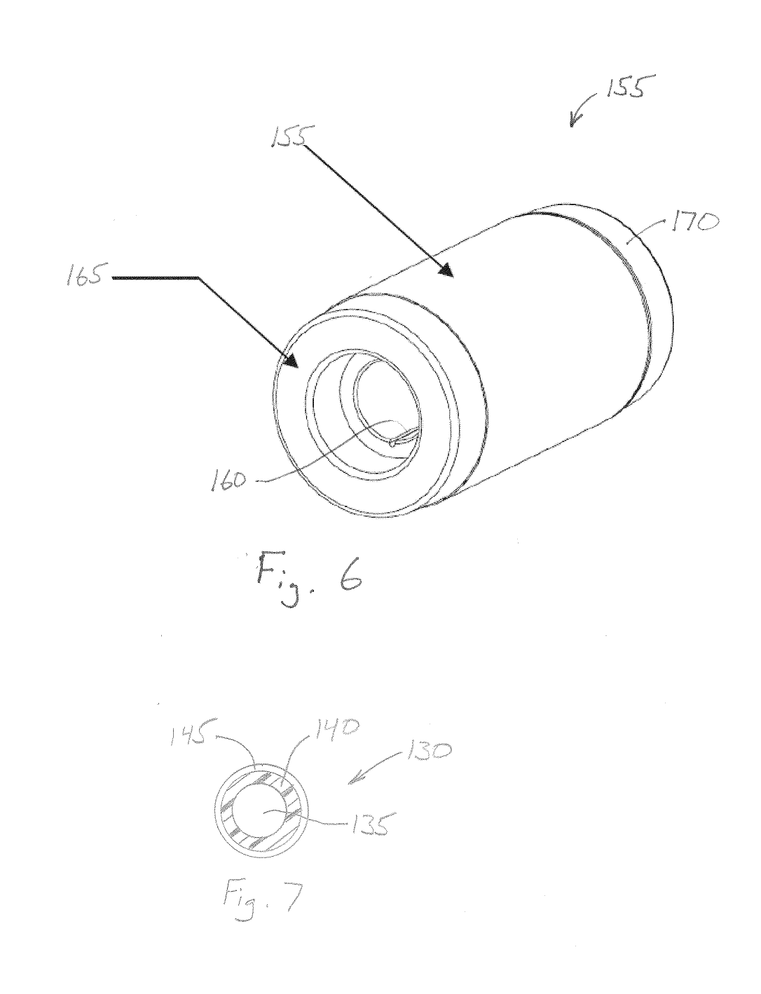

The rotor 40 is formed using conventional materials and techniques. The rotor 40, illustrated in FIG. 6 includes a rotor core 155 formed from laminations of electrical grade steel or aluminum stacked along the rotational axis 70 to a desired length. In other constructions, portions of the core 155 may be formed from powdered metal or other components. Rotor bars 160 extend the length of the core 155 and are coupled to end rings 165, 170 disposed at each end of the core 155. In preferred constructions, the bars 160 and end rings 165, 170 are formed using aluminum with other materials being possible.

The motor 25 formed of the indicated materials is more resistant to attack by ammonia than prior motors. The motor 25 can be mounted in the refrigeration system 10 in contact with ammonia, and the refrigeration system 10 is suitable for operation with the motor 25 in contact with ammonia. Therefore, the refrigeration system 10 can be simply and inexpensively constructed without sealing the motor 25 from the ammonia.

Various features and advantages of the invention are set forth in the following claims.

What is claimed is:

1. A motor for use within a refrigerant atmosphere, the motor comprising:
a plurality of laminations stacked along an axis, the laminations cooperating to define a plurality of teeth and a slot disposed between each pair of adjacent teeth;
a plurality of coils each positioned around a tooth such that each coil is partially disposed in two adjacent slots;
a first phase winding formed from at least two coils, the first phase winding including a single continuous conductor;
an insulating member disposed within each of the slots and arranged to electrically insulate the coil within the respective slot from the laminations;
a wedge positioned within at least one of the slots, the wedge operable to compress the coil within the slot; and
a rotor positioned adjacent the stator and operable to rotate about the axis.

2. The motor of claim 1, wherein each of the teeth includes a first hook and a second hook and wherein the first hook is positioned to engage the wedge.

3. The motor of claim 1, wherein the single continuous conductor includes a wire formed from a material elected from the group consisting of aluminum and copper, and an extruded insulator covering the wire.

4. The motor of claim 3, wherein the extruded insulator is formed from polyetheretherketone (PEEK) material.

5. The motor of claim 1, wherein he insulating member includes a polyphenylene sulfide (PPS) sheet having a thickness between about 0.01 and 0.02 inches.

6. The motor of claim 1, further comprising a second phase winding formed from at least two coils and including a single continuous conductor, the second phase winding being separate from the first phase winding.

7. The motor of claim 6, further comprising a third phase winding formed from at least two coils and including a single continuous conductor, the third phase winding being separate from the first phase winding and the second phase winding.

8. The motor of claim 7, further comprising an interphase insulator disposed between at least a portion of the coils that define the first phase winding and the second phase winding.

9. The motor of claim 1, wherein the wedge is at least partially manufactured from a material selected from the group of epoxide laminate, polyphenylene sulfide (PPS), and polyetheretherketone (PEEK).

10. A refrigeration system comprising:
a compressor chamber sized to contain a quantity of refrigerant;
a compressor disposed within the compressor chamber and operable to draw in low pressure refrigerant from the compressor chamber and to discharge high pressure refrigerant;
a motor completely disposed within the compressor chamber and coupled to the compressor to drive the compressor, the motor including;
a rotor positioned to rotate about a rotational axis; and
a stator positioned adjacent the rotor and cooperating with the rotor to produce rotation of the rotor, the stator including a first phase winding, wherein the first phase winding is formed by a single continuous conductor.

11. The refrigeration system of claim 10, wherein the compressor and the motor are directly coupled to one another such that they each rotate at the same speed.

12. The refrigeration system of claim 10, wherein the stator includes a plurality of laminations stacked along the rotational axis, the laminations cooperating to define a plurality of teeth and a slot disposed between each pair of adjacent teeth

13. The refrigeration system of claim 12, wherein the first phase winding includes a first coil positioned around a first tooth and a second coil positioned around a second tooth.

14. The refrigeration system of claim 13, further comprising a wedge positioned within a first of the plurality of slots, the wedge operable to compress the first coil within the first slot.

15. The refrigeration system of claim 13, further comprising an insulating member disposed within the first slot and arranged to electrically insulate the first coil within the first slot from the laminations.

16. The refrigeration system of claim 15, wherein the insulating member includes a polyphenylene sulfide (PPS) sheet having a thickness between about 0.01 and 0.02 inches.

17. The refrigeration system of claim 10, wherein the single continuous conductor includes a wire formed from a material elected from the group consisting of aluminum and copper, and an extruded insulator covering the wire.

18. The refrigeration system of claim 17, wherein the extruded insulator is formed from polyetheretherketone (PEEK) material.

19. The refrigeration system of claim 10, further comprising a second phase winding formed from at least two coils and including a single continuous conductor, the second phase winding being separate from the first phase winding, and a third phase winding formed from at least two coils and including a single continuous conductor, the third phase winding being separate from the first phase winding and the second phase winding.

20. The refrigeration system of claim 19, further comprising a variable frequency drive operable to drive the motor at a desired speed that is variable.
